(19) United States
(12) Patent Application Publication
(10) Pub. No.: US 2017/0113436 A1
(43) Pub. Date: Apr. 27, 2017

(54) DUCT TAPE HAVING A MULTI-LAYER ADHESIVE SYSTEM

(71) Applicant: Intertape Polymer Corp., Sarasota, FL (US)

(72) Inventors: John K. Tynan, Jr., Marysville, MI (US); Paul E. Rhude, Fort Gratiot, MI (US)

(21) Appl. No.: 15/299,770

(22) Filed: Oct. 21, 2016

Related U.S. Application Data
(60) Provisional application No. 62/244,218, filed on Oct. 21, 2015.

(51) Int. Cl. B32B 7/12; B32B 27/32; B32B 27/08; B32B 3/26

(52) U.S. Cl. CPC B32B 7/12; B32B 3/26; B32B 27/32; B32B 27/08; B32B 2405/00

(57) ABSTRACT

A low cost, thick duct tape having a multi-layer adhesive system and methods for making the duct tape are disclosed. The duct tape includes a backing having a first major surface and an opposing second major surface, a reinforcing material applied to the second major surface of the backing, an inner adhesive layer applied to the reinforcing material opposite the backing, and an outermost adhesive layer applied to the composite adhesive layer. The inner adhesive layer includes a first adhesive and an extender dispersed in the first adhesive, and the outermost adhesive layer includes a second adhesive that may be the same or different than the first adhesive.

### RELATED APPLICATIONS

This application claims the benefit of U.S. Provisional Application No. 62/244,218, filed Oct. 21, 2015, herein incorporated by reference.

### TECHNICAL FIELD

The present disclosure relates to an adhesive tape, in particular, an adhesive duct tape having a bi-layer adhesive system, and processes for making the same.

### BACKGROUND

Adhesive duct tapes are well known in the art. Duct tapes are widely used for purposes such as seaming metal ductwork, securing insulation, and other uses. Generally, traditional duct tapes include a backing material, a bi-directional reinforcing scrim material, and a pressure-sensitive adhesive. Duct tape is a commodity, and producers of duct tape are sensitive to fluctuations in the cost of materials and production. For many years, producers have explored approaches to reduce the costs of producing duct tapes while maintaining performance. Many such approaches have involved reducing material costs associated with the backing material, scrim material, and pressure-sensitive adhesive, but better cost-effective solutions are still needed.

### SUMMARY

The present disclosure is directed to a low cost, heavy thickness, duct tape having a backing, a reinforcing material, and a multi-layer adhesive system. In one aspect, the duct tape includes a backing having a first major surface and an opposing second major surface, a reinforcing material applied to the second surface of the backing, an inner adhesive layer, comprising a first adhesive having an extender dispersed therein, applied to the reinforcing material, and an outermost adhesive layer, having a second adhesive, applied to the inner adhesive layer. The first adhesive and the second adhesive may be the same or different.

In all aspects, the inner adhesive layer and the outermost adhesive layer together define an adhesive thickness, and the inner adhesive layer is about 5% to about 95% of the adhesive thickness. The extender is about 30% to about 95% per unit weight of the inner adhesive layer, and may be one or more of calcium carbonate, clay, glass microspheres, shredded polyethylene film, shredded polypropylene film, wood flour, or duct tape scrap.

In all aspects, the first adhesive and the second adhesive are both selected from the group consisting of a natural rubber adhesive, natural rubber polymer blend, SIS block copolymer, SBS block copolymer, SIBS block copolymer, hot melt acrylic adhesive, and combinations thereof. In one embodiment, the first adhesive and the second adhesive are the same, and are a natural rubber adhesive.

In all aspects, the reinforcing material has a plurality of voids. The plurality of voids may be filled by all or partially by the composite adhesive layer or the backing. In one embodiment, the backing has a base layer and a barrier layer, where the base layer defines the second major surface of the backing. Here, the barrier layer fills at least partially the plurality of voids therein. In one embodiment, the backing comprises a polyolefin and the barrier layer comprises ethylene vinyl acetate or ethylene methylacrylate.

According to another aspect, processes of making duct tape are disclosed. The process includes providing a backing having a first major surface and an opposing second major surface, providing a reinforcing material, applying the reinforcing material to the second major surface of the backing, applying an inner adhesive layer to the reinforcing material opposite the backing, wherein the inner adhesive layer comprises an extender dispersed in a first adhesive, wherein the extender is about 30% to about 95% per unit weight of the inner adhesive layer, and applying an outermost adhesive layer, comprising a second adhesive, to the inner adhesive layer opposite the reinforcing material. The first adhesive and the second adhesive may be the same or different.

In one embodiment, applying the inner adhesive layer to the reinforcing material and/or backing includes passing the backing and reinforcing material through a slot die or a multi-roll calender, and applying the outermost adhesive layer includes passing the backing, reinforcing material, and inner adhesive layer through a slot die or a multi-roll calender.

In one embodiment, the backing comprises a polyolefin, and the process further includes heating the backing to soften the backing, and embedding the reinforcing material at least partially in the second major surface of the backing, which may be defined by a barrier layer. This barrier layer may comprise ethylene vinyl acetate or ethylene methylacrylate.

### DESCRIPTION OF THE DRAWINGS

The foregoing and other aspects of the present disclosure will become more fully apparent from the following drawings, which include additional specificity and detail including exaggerated thicknesses of the various layers for ease of illustration and understanding. The drawings depict several embodiments in accordance with the disclosure, but are not to be considered limiting.

FIG. 1 is a perspective view of a roll of duct tape.

FIG. 2 is an enlarged cross-sectional view of an embodiment of duct tape taken along line 2-2 in FIG. 1.

FIG. 3 is an enlarged cross-sectional view of another embodiment of duct tape having a reinforcing material at least partially embedded in a film layer.

### DESCRIPTION

Many efforts have been made to reduce the costs of producing duct tapes while maintaining their performance. Traditional duct tapes have relied on a large mass of adhesive to achieve the desired performance. This traditional practice created a perception among consumers that a thicker duct tape is a stronger duct tape. This expectation persists despite recent advances in adhesive technology, such as improvements in shear resistance and UV resistance, that can reduce the amount of adhesive material necessary to produce high quality duct tape, thereby reducing the thickness of the duct tape. Consumers of duct tape still perceive that a thicker duct tape is superior. Therefore, among other advantages, the duct tape disclosed and described herein is a lower-cost duct tape that takes advantage of advances in adhesive technology, while at the same time having an adhesive overall thickness that satisfies consumer perceptions.

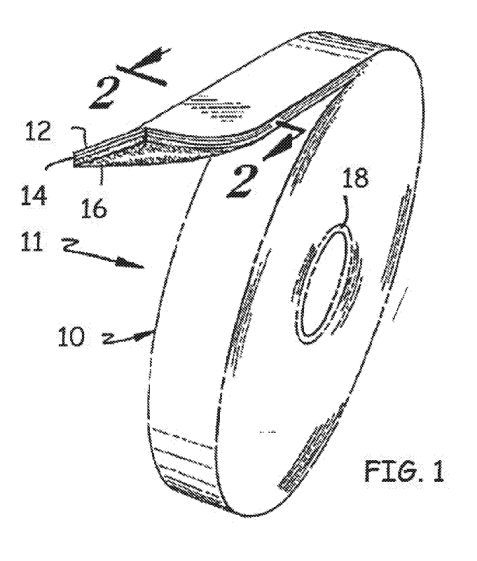

The duct tapes, disclosed herein, utilize a multi-layer adhesive system to achieve a desired thickness of adhesive and overall duct tape thickness, while reducing adhesive material costs. Referring now to FIGS. 1-3, the multi-layer adhesive system 16 has a first adhesive layer 40, 40′ and an outermost, second adhesive layer 50. The first adhesive layer 40, 40′ is an inner adhesive layer based on its relative position compared to an outermost adhesive layer 50. The first adhesive layer 40, 40′ includes an amount of extender 46 to increase the overall thickness of the duct tape 10 while at the same time reducing the cost of adhesive material. The second adhesive layer 50, the outermost adhesive layer, is a functional layer applied in an amount to provide desired performance characteristics, such as adhesion, shear resistance, and UV resistance for example, to the duct tape 10.

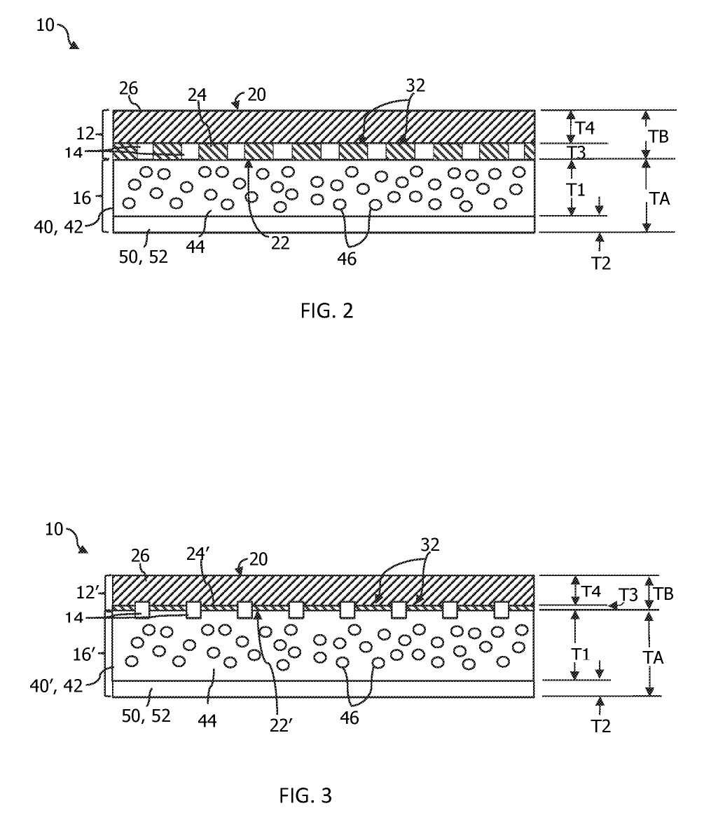

Referring to FIG. 1, a roll 11 of duct tape 10 wound onto a core 18 is illustrated. The duct tape 10 has a backing layer 12, a reinforcing material 14, and a multi-layer adhesive system 16. An enlarged cross-section of the duct tape 10 taken at line 2-2 is shown in FIG. 2. The duct tape 10 has a plurality of layers or laminations, which include the backing layer 12, the reinforcing material 14, and the multi-layer adhesive system 16. The backing layer 12 has a first surface 20 (indicated as facing towards the top of FIG. 2) and a second surface 22 (facing towards the bottom of FIG. 2). The backing layer 12 in FIG. 2 is a multi-layer film having a base layer 26 and a barrier layer 24, wherein the barrier layer 24 serves to prevent penetration of adhesive materials from the multi-layer adhesive system 16 and reinforcing material 14, into the base layer 26, and through the base layer 26 to the first surface 20. The backing layer 12 can also have a release layer (not shown) as the outermost layer to prevent the duct tape 10 from adhering to itself when wound onto the core 18 following manufacturing of the duct tape 10. In one embodiment, the backing layer 12 does not include the barrier layer or the release layer.

The reinforcing material 14 has a plurality of voids 32 and is positioned adjacent to the second surface 22 of the backing layer 12. Adjacent to the reinforcing material 14 on the side opposite the backing layer 12 is the multi-layer adhesive system 16, which includes at least a first adhesive layer 40 and a second adhesive layer 50. The first adhesive layer 40 is comprised of a composite adhesive 42, which includes, but is not limited to, at least a first adhesive 44 and an extender 46 interspersed within the first adhesive 44.

In an embodiment, similar to FIG. 2, material from the first adhesive layer 40 penetrates into the voids 32 in the reinforcing material 14 and fills the voids 32 rather than or in addition to the barrier layer 24 (see FIG. 3 for this particular variation). An amount of composite adhesive 42 that fills the void spaces 32 ranges from about 5% to about 30% per volume of the first adhesive layer 40, more preferably about 10% to about 30% per volume thereof. In one embodiment, the composite adhesive 42 fills the void spaces with about 20% to about 30% by volume of the first adhesive layer 40.

The second adhesive layer 50 is a functional adhesive layer and is comprised of a second adhesive 52, that can be the same or different than the first adhesive 44 of the first adhesive layer 40. As illustrated in FIGS. 2 and 3, the second adhesive layer 50 does not include an extender 46.

As labeled in FIGS. 2 and 3, the first adhesive layer 40, 40′ and the second adhesive layer 50 together define an adhesive thickness TA. The first adhesive layer 40 defines a first thickness T1 and the second adhesive layer 50 defines a second thickness T2. The first adhesive layer 40 can be applied in an amount such that the first thickness T1 is in a range of about 5% to about 95% of the adhesive thickness TA, preferably about 10% to about 90% of the adhesive thickness TA, more preferably about 20% to about 80% of the adhesive thickness TA, and even more preferably about 30% to about 75% of the adhesive thickness TA. However, to impart greater cost saving, it is preferred that the second adhesive layer is thinner than the first adhesive layer by having the first adhesive layer comprise greater than 50% of the adhesive thickness TA with the second adhesive layer comprising the balance.

The extender 46 in the composite adhesive of the first adhesive layer 40 is a filler material added to increase the bulk and thickness of the duct tape 10 and reduce the amount of adhesive needed to make the duct tape, among other purposes. The extender 46 is preferably a low density, low cost material that is viable in the adhesive layer. Suitable extender/filler materials include, but are not limited to, calcium carbonate, clay, glass spheres, shredded polyethylene, shredded polypropylene, wood flour, recycled paper, duct tape scrap, trim scrap, other filler material, or combinations thereof. In one embodiment, the extender can be a finely ground wood flour. In another embodiment, the extender can be finely shredded polyethylene film scrap and/or virgin material. In another embodiment, the extender can be finely shredded polypropylene film scrap material.

The incorporation of such extenders into the adhesive without jeopardizing the cohesive strength of the adhesive is important. The particle size of the extender is a factor in finding suitable cohesive strengths. Smaller particle size is typically better due to the fact that the extender incorporates into the polymer matrix. The average particle size for the extender is typically in a range of about 0.001 μm to about 6000 μm, more preferably about 1 μm to about 3000 μm, and even more preferably about 5 μm to about 2000 μm. Also, a balance should be achieved between maximizing cohesive strength versus maximizing density reduction.

The first adhesive 44 can be a pressure-sensitive adhesive (PSA). Typical varieties of PSA's are derived from natural rubber, synthetic rubber, acrylic, silicone and modifications thereof. The following adhesive compounds, solutions, or emulsions may be used, either alone or in combination, without departing from the scope of this invention. Suitable rubber-based adhesives include, but are not limited to, natural rubber, synthetic polyisoprene, styrene-isoprene-styrene block copolymer (SIS), styrene-butadiene-styrene block copolymer (SBS), styrene-isoprene-butadiene-styrene block co-polymer (SIBS), styrene-ethylene-butylene-styrene block co-polymer (SEBS), styrene-ethylene-propylene-styrene block copolymer (SEPS), styrene butadiene rubber, nitrile rubber, neoprene rubber, butyral and butyl rubber, polyisobutylene, polysulfide rubber, silicone rubber, natural latex rubber, and synthetic latex rubber. Suitable resin-based adhesives include, but are not limited to, polyvinyl acetate, polyvinyl butyral, polyvinyl chloride, acrylic, ethylene vinyl acetate, polyethylene-based, polyolefin based, nylon-based, phenol-based (including formaldehyde-based), urea-based (including formaldehyde-based), epoxy resin, polyurethane-based, rosin-based (including rosin esters), polyterpene-based, polyester, petroleum-based, and low-molecular-weight-based adhesives. In one embodiment, the first adhesive can be a natural rubber adhesive. In one embodiment, the first adhesive can be an SIS block copolymer. In one embodiment, the first adhesive can be a hot melt acrylic adhesive material.

The relative amounts of extender 46 and first adhesive 44 in the composite adhesive of the first adhesive layer 40 are selected to obtain a desired thickness of the duct tape. In one embodiment, the composite adhesive can include an amount of extender 46 in a range from about 30% to about 90% per unit weight of composite adhesive and an amount of the first adhesive 44 in a range from about 10% to about 70% per unit weight of composite adhesive. In another embodiment, the composite adhesive can include an amount of extender 46 in a range from about 40% to about 85% per unit weight of composite adhesive and an amount of the first adhesive 44 in a range from about 15% to about 60% per unit weight of composite adhesive. In another embodiment, the composite adhesive can include an amount of extender 46 in a range from about 50% to about 80% per unit weight of composite adhesive and an amount of first adhesive 44 in a range from about 20% to about 50% per unit weight of composite adhesive.

The second adhesive 52 of the second adhesive layer 50 is typically a pressure-sensitive adhesive (PSA) for duct tapes. The second adhesive can be a natural rubber, a natural rubber polymer blend, an SIS block copolymer, an SBS block copolymer, and SIBS block copolymer, a hot melt acrylic adhesive, or combinations thereof. In one embodiment, the second adhesive can be a natural rubber. In another embodiment, the second adhesive can be a hot melt acrylic adhesive. In one embodiment, the second adhesive can be an SIS block copolymer.

Referring again to FIGS. 2 and 3, the backing 12, 12′ (or backing layer) has a first surface 20, which can also be referred to as a release surface, and a second surface 22, 22′ which can be referred to in the alternative as an adhesive surface because the first adhesive layer is applied directly thereto. Generally, the first surface 20 faces away from the reinforcing material 14 and the multi-layer adhesive system 16, and the second surface 22 faces toward the reinforcing material 14 and the multi-layer adhesive system 16. Portions of the backing 12 closest to the multi-layer adhesive system 16 can be referred to as the adhesive side of the backing 12, and portions of the backing layer 12 furthest from the multi-layer adhesive system 16 can be referred to as the release side of the backing 12.

The backing 12 can be comprised of any known flexible support material commonly used for such purposes. Flexible support materials can include, for example, cellulose esters, polyesters, polyolefins, other support materials or combinations thereof. Cellulose esters can include, for example, cellulose acetate, cellulose triacetate, and the like. Polyesters can include polyethylene terephthalate, for example. Polyolefins can include polyethylenes, polypropylenes, other polyolefins, and combinations thereof, and can be high density, low density, or linear low density polyolefins, and combinations thereof. In one embodiment, the backing is a polyethylene film. The backing can also include other components such as colorants, flame retardants, fillers, recycled content, UV additives, release agents, adhesion promoters, other materials, or combinations thereof. In another embodiment, the backing may be a metalized layer, such as aluminum. Any of the backings may have the surface energy of one or more surfaces thereof enhanced by known treatments. For example, chemical treatment, flame treatment, plasma treatment, corona treatment, or combinations thereof enhance the bond between the backing and subsequent coatings, including the adhesive layer and/or release layers, etc. In another embodiment, the backing may include coextruded skin layers, such as polybutene copolymer, EMA, or other such layers to enhance the bond of the adhesive to the backing, especially when the backing is a film.

In one embodiment, the backing 12 can be a multi-layer film, which can include, but is not limited to, one or more of a barrier layer 24, which may be a skin layer because of its relative small thickness as a layer, a base layer 26, a release layer, other layers, or combinations thereof. A base layer 26 can be a backing material according to the above-mentioned discussion of backing materials. A barrier layer 24 can be included to prevent penetration or migration of adhesive material into and/or through the base layer 26 of the backing, enabling a producer of the duct tape to use a lower cost material for the base layer 26, thereby realizing an overall reduction in material costs associated with the backing layer 12, and the other benefits identified above. The barrier layer 24 can be comprised of an ethylene vinyl acetate (EVA) film, ethylene methylacrylate (EMA) film, other film, or combinations thereof. In one embodiment similar to FIG. 2, the barrier layer 24 is positioned along the adhesive side of the backing layer 12.

Referring to FIGS. 2 and 3, the base layer 26 and the barrier layer 24, 24′ together define a backing thickness TB. The barrier layer 24, 24′ defines a third thickness T3 and the base layer 26 defines a fourth thickness T4. The barrier layer 24 can be applied in an amount such that the third thickness T3 is in a range of about 0% to about 50% of the backing thickness TB. In one embodiment, the barrier layer 24 can be applied in an amount such that the third thickness T3 is in a range of about 1% to about 25% of the backing thickness TB, in a range of about 2% to about 12% of the backing thickness TB, and more in a range of about 4% to about 6% of the backing thickness TB.

In one embodiment, a multi-layer backing can have a release layer positioned on the release side of the multi-layer backing and facing away from the multi-layer adhesive system, which contributes to the backing thickness TB. The release layer prevents the duct tape from sticking to itself upon being wound onto a core following making of the duct tape. The release layer can include, but is not limited to, any commercially available release compound or mixture of compounds, such as a silicone release compound or polyvinyl octadecyl carbamate (PVODC), for example.

The overall duct tape thickness is the sum of TA and TB. Typical overall duct tape thickness (or caliper) is between about 1.5 mils to 25 mils, with a backing thickness in the range of about 1 mil to 15 mils. Heavy duty duct tapes and other specialty duct tapes have overall thickness generally in the range of 9 mil to 25 mils, whereas all-purpose duct tapes typically have an overall thickness in the range of about 3 mils to 9 mils, with the average being about 6 to 6.5 mils.

Still referring to FIG. 2, the reinforcing material 14, which is generally positioned between the backing layer 12 and the multi-layer adhesive system 16, provides reinforcement to the duct tape structure and promotes tearability of the duct tape 10 upon dispensing it from the roll. Reinforcing material 14 can also be referred to in the alternative as scrim or scrim material. Reinforcing material 14 can be a bi-directional material, such as a woven material for example, and can be made from, but not limited to, natural fibers such as cotton or wool, synthetic fibers such as polyester fibers, or combinations thereof. In one embodiment, the reinforcing material can be a synthetic fiber. In one embodiment, the reinforcing material can be a polyester fiber.

Because the reinforcing material 14 is generally bi-directional and/or woven, the reinforcing material 14 has a plurality of voids 32 between the fibers making up the reinforcing material 14. When the duct tape 10 is made, adhesive materials from the multi-layer adhesive system 16 flow, migrate, or penetrate into these voids 32 and at least partially fill the voids 32. To reduce an amount of adhesive material that migrates into these voids 32, the reinforcing material 14 can be partially or fully embedded in the backing as shown in FIG. 3. In one embodiment, the reinforcing material can be partially embedded into a barrier layer 24 of a multi-layer film. Embedding the reinforcing material in the barrier layer reduces the amount of adhesive material present in the voids, thus reducing adhesive costs. Among other benefits, embedding the reinforcing material 14 in the film layer also stabilizes the reinforcing material relative to the film layer during application of the multi-layer adhesive system, in particular the subsequent adhesive coating process. For example, backing material in the voids prevents the reinforcing material 14 from being disturbed, for example rolled up, and their caliper subsequently increased.

In one embodiment, the reinforcing material 14 is embedded in the backing layer 12. This fills or at least partially fills the void spaces in the reinforcing material 14 with material from the backing layer 12. As such, the amount of first adhesive 44 from the first adhesive layer 40 to fill the void spaces in the reinforcing material 14 is reduced. With reference to FIGS. 2 and 3, the reinforcing material 14 may be partially or fully embedded within the barrier layer 24′ such that the reinforcing material 14 deforms into the second surface 22′ of the backing layer 12′ and the barrier layer 24′ at least partially penetrates into and at least partially occupies or fills in a plurality of voids 32 in the reinforcing material 14. FIG. 2 illustrates the reinforcing material 14 fully embedded in the barrier layer 24 such that the material of the barrier layer 24 substantially fills all of the voids 32. FIG. 3 illustrates a duct tape 10′ having the reinforcing material 14 at least partially embedded in a barrier layer 24′ of a backing layer 12′. Here, the first adhesive layer 40′ is a composite adhesive 42 having a first adhesive 44 and an extender 46 in a relative proportion selected to achieve a desired thickness of the duct tape 10′ and reduce material costs. The composite adhesive 42 penetrates into the remaining voids 32 in the reinforcing material 14 until the composite adhesive 42 contacts the lower surface 22′ of the backing layer 12′.

In another embodiment (not shown), if the barrier layer 24, 24′ is not present, then the reinforcing material 14 can be partially or fully embedded in the base layer 26 of the backing by heating the backing layer 12 and using a force, such as that created at the nip between two rollers for example, to press the reinforcing material 14 into the heated base layer. This process is also appropriate when the barrier layer 24, 24′ is present, i.e., to embed the reinforcing material in the backing layer, the backing is heated and softened by exposing the backing to a heat source, such as by passing the backing through an oven or passing the backing over a heated conditioning roll, for example. Once the backing is heated and softened, the reinforcing material can be embedded into the backing. In one embodiment, force can be applied to the reinforcing material to embed the reinforcing material in the backing. In one embodiment, the backing can be a multi-layer film having a base layer and a barrier layer, and the reinforcing material can be embedded into the barrier layer.

A process for making a thick, low-cost duct tape having a multi-layer adhesive system can include, but is not limited to: selecting a backing having a first surface and a second surface; heating the backing to soften the backing material; embedding a reinforcing material in the second surface of the backing, which may include a barrier layer; applying a first adhesive layer adjacent to the reinforcing material on a side of the reinforcing material opposite from the backing, wherein the first adhesive layer comprises a first adhesive and an extender; and applying a second adhesive layer adjacent to the first adhesive layer. In the heating step, the backing material can be heated using an oven, a heated conditioning roll, or other heating apparatus. In one embodiment, the backing can have a barrier layer and the heating apparatus can be positioned such that the heating apparatus heats and softens the barrier layer. During embedding, a force can be applied to the reinforcing material to embed the reinforcing material in the backing. Applying the first adhesive layer may be accomplished using a slot die, a calender operation, or other operation, for example. Applying the second adhesive layer may be accomplished using a slot die, a calender operation, or other operation. In one embodiment, the first adhesive layer is applied using a calender operation and the second adhesive layer is applied using a slot die operation.

In one embodiment, the method includes providing a polyethylene backing having a first surface and a second surface; heating the backing to soften the backing material; under force, embedding a reinforcing material in the second surface of the backing; applying a cost effective first adhesive layer adjacent to the reinforcing material on a side of the reinforcing material opposite from the backing via a calander process; and applying a high performance second adhesive layer adjacent to the first adhesive layer via a slot die method.

Having described the invention in detail and by reference to preferred embodiments, it will be apparent that modifications and variations thereof are possible without departing from the scope of this invention. The tape is preferably a duct tape, but is not limited thereto.

What is claimed is:

1. A duct tape comprising:
a backing having a first major surface and an opposing second major surface;
a reinforcing material applied to the second surface of the backing;
an inner adhesive layer, comprising a first adhesive having an extender dispersed therein, applied to the reinforcing material; and
an outermost adhesive layer, comprising a second adhesive, applied to the inner adhesive layer.

2. The duct tape of claim 1 wherein the inner adhesive layer and the outermost adhesive layer together define an adhesive thickness, and the inner adhesive layer comprises about 5% to about 95% of the adhesive thickness.

3. The duct tape of claim 1 wherein the extender comprises about 30% to about 95% per unit weight of the inner adhesive layer.

4. The duct tape of claim 1 wherein the extender comprises one or more of calcium carbonate, clay, glass microspheres, shredded polyethylene film, shredded polypropylene film, wood flour, and ground or shredded duct tape.

5. The duct tape of claim 1 wherein the extender comprises wood flour.

6. The duct tape of claim 1 wherein the first adhesive and the second adhesive are both selected from the group consisting of a natural rubber adhesive, natural rubber polymer blend, SIS block copolymer, SBS block copolymer, SIBS block copolymer, hot melt acrylic adhesive, and combinations thereof.

7. The duct tape of claim 6 wherein the first adhesive and the second adhesive are the same.

8. The duct tape of claim 6 wherein the first adhesive and the second adhesive are each a natural rubber adhesive.

9. The duct tape of claim 1 wherein the reinforcing material has a plurality of voids, and the composite adhesive layer fills at least a portion of the plurality of voids.

10. The duct tape of claim 1 wherein the backing has a base layer and a barrier layer, wherein the barrier layer defines the second major surface of the backing.

11. The duct tape of claim 10 wherein the reinforcing material has a plurality of voids at least partially filled by the barrier layer.

12. The duct tape of claim 11 wherein the backing comprises a polyolefin and the barrier layer comprises ethylene vinyl acetate or ethylene methylacrylate.

13. The duct tape of claim 10 wherein the base layer and the barrier layer together define a backing thickness, and the barrier layer comprises about 5% to about 95% of the backing thickness.

14. A process for making a duct tape having a multi-layer adhesive system, the process comprising:
providing a backing having a first major surface and an opposing second major surface;
providing a reinforcing material;
applying the reinforcing material to the second major surface of the backing;
applying an inner adhesive layer to the reinforcing material opposite the backing, wherein the inner adhesive layer comprises an extender dispersed in a first adhesive, wherein the extender is about 30% to about 95% per unit weight of the inner adhesive layer; and
applying an outermost adhesive layer, comprising a second adhesive, to the inner adhesive layer opposite the reinforcing material.

15. The process of claim 14 wherein applying the inner adhesive layer includes passing the backing and reinforcing material through a slot die or a multi-roll calender; and applying the outermost adhesive layer includes passing the backing, reinforcing material, and inner adhesive layer through a slot die or a multi-roll calender.

16. The process of claim 14 wherein the inner adhesive layer and the outermost adhesive layer together define an adhesive thickness, and the inner adhesive layer comprises about 5% to about 95% of the adhesive thickness.

17. The process of claim 14 wherein the backing comprises a polyolefin, and the process further comprises heating the backing to soften the backing, and embedding the reinforcing material at least partially in the second major surface of the backing.

18. The process of claim 17 wherein the backing has a base layer and a barrier layer, wherein the barrier layer was softened by the heating of the backing and the reinforcing material is at least partially embedded in the barrier layer.

19. The process of claim 18 wherein the barrier layer comprises ethylene vinyl acetate or ethylene methylacrylate.

20. The process of claim 18 wherein the base layer and the barrier layer together define a backing thickness, and the barrier layer comprises about 1% to about 50% of the backing thickness.
